(19) United States
(12) Patent Application Publication
(10) Pub. No.: US 2026/0098557 A1
(43) Pub. Date: Apr. 9, 2026

(54) TELESCOPIC ROD LOCKING SYSTEM

(71) Applicant: Zhichao Feng, Zhangdian District (CN)

(72) Inventor: Zhichao Feng, Zhangdian District (CN)

(21) Appl. No.: 18/907,778

(22) Filed: Oct. 7, 2024

(51) Int. Cl. F16B 7/14

(52) U.S. Cl. CPC F16B 7/1418

(57) ABSTRACT

Described herein are telescopic rod locking systems comprising an outer tube; an inner tube configured to extend from and retract into the outer tube; a locking mechanism comprising a clamp body, a locking assembly comprising a first locking member and a second locking member configured to form a V-shaped or substantially V-shaped locking assembly slot; a locking bolt; a locking nut; and a handle. The clamp body may include a first axial end fixedly engaged with an outer tube, and a second axial end configured to releasably engage a corresponding inner tube, allowing the inner tube to be longitudinally locked or released relative to the outer tube. The systems described herein may further include an anti-rotation mechanism wherein a groove (or a protrusion) may be formed along the length of an outer surface of an inner tube, and a corresponding complimentary protrusion (or groove) may be formed along the length of an interior surface of a corresponding adjacent outer tube, thereby preventing or minimizing axial rotation between inner and outer tubes. Also described herein are multi-stage telescopic rod locking systems that operate substantially identically to the single-stage systems described herein, except that they comprise a plurality of inner tube/outer tube/locking mechanism systems.

### FIELD

The present description relates to the field of telescopic systems, more specifically to systems used for locking adjustable-length rods or poles.

### BACKGROUND

Telescopic rods and tubes are commonly used in various industries, including construction, cleaning, and photography, to provide adjustable-length supports or poles. These systems typically include an inner tube that extends and retracts within an outer tube, allowing for length adjustment as needed. A locking mechanism is often included to fix the position of the inner tube relative to the outer tube.

One of the common challenges in conventional telescopic systems is unwanted rotational movement between the inner and outer tubes during operation. This rotational slippage can cause misalignment, reduce efficiency, and lead to wear and damage over time. In addition, existing clamping mechanisms may not provide sufficient locking force, or may require frequent adjustments to maintain a secure hold on the inner tube.

### SUMMARY

The telescopic rod locking systems described herein may include an outer tube, an inner tube configured to extend from and retract into the outer tube, and a locking mechanism. The locking mechanism may comprise a locking assembly, a clamp body, a locking bolt, a locking nut, and a handle. The clamp body may comprise a first axial end fixedly attached to the outer tube and a second axial end releasably engaged with the inner tube, allowing for the inner tube to be locked or released longitudinally.

In an embodiment, the system includes a groove formed along the length of either an inner tube or an outer tube, and a corresponding protrusion formed on the other tube. The groove and protrusion engage to prevent or minimize rotational movement between the inner and outer tubes. In an embodiment, the groove may be positioned on an outer surface of the inner tube, and the protrusion may be positioned on an inner surface of the outer tube. In one variation, two grooves and two corresponding protrusions may be symmetrically positioned around the circumference of the tubes.

Systems described herein may further comprise a locking mechanism comprising a clamp body operatively connected to a handle. The locking mechanism may include a locking assembly comprising first and second locking members that move radially inward when the handle is rotated to engage the inner tube. In one embodiment, the locking members may include inclined surfaces that interact with the handle to generate clamping force. The first and second locking members may be configured relative to one another so as to define a V-shaped or substantially V-shaped slot. A locking bolt may pass through the locking members and engage with a locking nut to control radial movement of the locking members.

The first axial end of the clamp body may be fixedly attached to the outer tube through fastening mechanisms such as bolts, rivets, or adhesives. The inner and outer tubes may have circular or non-circular cross-sectional shapes. In an embodiment, the inner tube may include a reinforced portion at its end where the groove is formed.

Other embodiments of the telescopic rod locking systems described herein will become apparent from the following detailed description, the accompanying drawings, and the appended claims.

### BRIEF DESCRIPTION OF THE DRAWINGS

FIG. 1 is a perspective view of a locking mechanism as described herein, illustrating the locking members, handle, and locking bolt.

FIG. 2 is a side view of a locking mechanism as described herein, showing the relationship between the handle, the locking bolt, and the first and second axial ends.

FIG. 3 is a cross-sectional view of a locking mechanism as described herein within a clamp body as described herein, depicting the interaction between the handle, locking bolt, hexagonal nut, and locking members.

FIG. 4 is an exploded view of a locking mechanism according to this disclosure, showing the handle, locking bolt, and locking assembly.

FIG. 5 is a perspective view of a second axial end of the clamp body as described herein, highlighting the configuration of the locking assembly, including the locking members.

FIG. 6 is a perspective view of a first locking member as described herein, illustrating the inclined surface and arc-shaped surface used to engage the inner tube.

FIG. 7 is a cross-sectional view showing the interaction between the first locking member and second locking member during the clamping process.

FIG. 8 is a perspective view of a handle as described herein, showing the components used to engage and rotate the locking bolt.

FIG. 9 is a perspective view of the handle from another angle, highlighting the arc-shaped surface that interacts with the locking members.

FIG. 10 is a perspective view of a locking nut as described herein, showing its cylindrical or substantially cylindrical section and raised portion for engagement with the locking bolt.

FIG. 11 is a bottom perspective view of a locking nut as described herein, illustrating the hexagonal recess that fits over the locking bolt.

FIG. 12 is a perspective view of a telescopic rod locking system according to this disclosure, assembled with the inner and outer tubes.

FIG. 13 is a front view of a telescopic rod locking system as described herein, illustrating alignment of the inner and outer tubes when the system is locked.

FIG. 14 is a perspective view of an outer tube (above) and a corresponding inner tube (below), illustrating longitudinal protrusions on the inner surface of the outer tube and longitudinal grooves on the outer surface of the inner tube.

FIG. 15 is a cross-sectional view of an outer tube (above) and a cross-sectional view of a corresponding inner tube (below), illustrating longitudinal protrusions on the inner surface of the outer tube and longitudinal grooves on the outer surface of the inner tube.

FIG. 16 is a perspective view of an assembled anti-rotation mechanism as described herein, illustrating engagement between grooves on an inner tube and protrusions on an outer tube.

FIG. 17 is a perspective view of a telescopic rod locking system enabled by this disclosure in a fully collapsed state, illustrating a series of inner and outer tubes as described herein nested within one another with clamps securing each inner tube in place.

FIG. 18 is a perspective view of a telescopic rod locking system as described herein in a partially extended state.

### DETAILED DESCRIPTION

Described herein are telescopic rod locking systems that incorporate several features that improve the stability, reliability, and versatility of telescopic mechanisms. The systems described herein are particularly well-suited for use in adjustable-length applications, such as carbon fiber poles, extendable arms, or support structures, where precise control over extension and retraction is important.

One aspect of this disclosure concerns an improved structural design that enhances locking. The locking mechanism may comprise a locking assembly, a clamp body, a locking bolt, a locking nut, and a handle. The locking assembly may comprise first and second locking members that move radially inward when the handle is rotated to engage the inner tube. The clamp body may comprise a first axial end fixedly attached to the outer tube and a second axial end releasably engaged with the inner tube, allowing for the inner tube to be locked or released longitudinally. The locking members may be positioned relative to one another so as to define a V-shaped or substantially V-shaped slot. The locking mechanism described herein provides enhanced locking force, smoother operation, and reduced wear on an inner tube during use. The locking members compress inwardly against the inner tube when the handle is rotated, securely holding the inner tube in place and preventing axial movement.

Another aspect of this disclosure concerns an anti-rotation mechanism, which prevents unwanted rotational movement between an inner tube and outer tube of a telescopic system. The anti-rotation feature described herein may be achieved through use of a groove and protrusion system, where one tube contains a longitudinal groove and the other tube has a corresponding protrusion. This mechanism ensures, or substantially ensures, that the tubes remain longitudinally aligned during extension and retraction without rotating relative to one another.

These two aspects—an improved clamping mechanism and an anti-rotation feature—can be used either independently or in combination within the same telescopic system, depending on the specific application. The anti-rotation feature may be integrated into various telescopic rod locking systems that require axial alignment, while the improved locking may be used in systems that prioritize enhanced locking functionality.

The telescopic rod locking systems described herein, therefore, provide a versatile and adaptable solution for various telescopic systems, combining stability, ease of use, and durability through its modular design. Whether used to prevent axial rotation or to provide enhanced locking and release mechanisms, the telescopic rod locking systems described herein offer significant improvements in performance and functionality.

The telescopic rod locking systems described herein may comprise an outer tube, an inner tube, and a locking mechanism that facilitates locking and adjustment of the inner tube relative to the outer tube. The outer tube may be configured to remain stationary while the inner tube may be movable, allowing for extension and retraction within the outer tube.

In an embodiment, the locking mechanism may be positioned at one end of the outer tube.

The clamp body may be divided into two primary sections: a first axial end and a second axial end. The first axial end may be fixedly attached to an outer tube, providing a stable base for the system, while the second axial end may be configured to engage with an inner tube.

The second axial end of the clamp body may include a locking assembly comprising locking members, for securely holding the inner tube in place when the system is in the locked position. These locking members may be positioned relative to one another to define a V-shaped, or substantially V-shaped, slot. These locking members may move radially inward to compress against the inner tube when actuated. This action prevents the inner tube from sliding or moving relative to the outer tube until the locking mechanism is released.

In an embodiment, the handle located on the clamp body controls locking. When rotated, the handle operates the locking bolt, which moves the locking members radially inward to engage the inner tube. This interaction allows the system to securely hold the inner tube in place, locking the telescopic system at a desired position. To release the lock and allow for telescopic adjustment, the handle is rotated in the opposite direction, which causes the locking members to retract, enabling smooth movement of the inner tube within the outer tube.

These structural components of the telescopic rod locking system ensure that the inner and outer tubes can be securely locked or freely adjusted as needed. The handle-operated locking mechanism described herein allows for precise control of the telescopic function.

The locking mechanism in the telescopic rod locking systems described herein provides a secure and reliable engagement between the inner tube and the outer tube, thereby ensuring or substantially ensuring stability during operation. The V-shaped, or substantially V-shaped, locking assembly slot, the locking bolt, the locking nut, and the handle, work together to control clamping of the inner tube.

The locking members of the locking assembly may be positioned within the second axial end of the clamp body. These members may be arranged in such a way that when the handle is actuated, they move radially inward toward the inner tube. The V-shaped, or substantially V-shaped, configuration of the locking members, thereby forming the locking assembly slot, allows the locking members to apply even and consistent pressure around the circumference of the inner tube, preventing it from moving axially.

In an embodiment, one side of each locking member may comprise an inclined surface, which assists in compressing the members against the inner tube when the mechanism is engaged. As the locking members move inward, their inclined surfaces come into contact with corresponding curved surfaces of the inner tube, further increasing clamping force applied to the inner tube. This configuration ensures, or substantially ensures, that the inner tube is securely held in place, preventing both longitudinal and rotational movement when the system is locked.

In an embodiment, the locking bolt connects the locking members to the handle. According to such embodiment, the locking bolt passes through the handle and engages with a locking nut, which allows the handle to rotate the bolt and control the movement of the locking members. When the handle is rotated in one direction, the locking bolt is driven through the locking members, urging them inward and compressing them against the inner tube. The locking nut at the end of the bolt ensures, or substantially ensures, that the bolt remains securely in place during operation, maintaining the desired clamping force.

The handle provides the user with a convenient way to engage or release the locking mechanism. In an embodiment, the handle may include a curved surface that interacts with the locking members and inclined surfaces as it rotates. According to this embodiment, when the handle is turned, the curved surface pushes against the locking members, causing them to move inward. Conversely, when the handle is rotated in the opposite direction, the locking members are allowed to move outward, releasing their grip on the inner tube and enabling telescopic adjustment.

This locking mechanism ensures, or substantially ensures, that the system can be easily locked or unlocked with minimal effort while providing a strong and secure hold on the inner tube when engaged. The combination of the locking members, locking bolt, and handle-operated mechanism results in smooth operation, enhanced clamping force, and quick-release functionality, making the system highly reliable and user-friendly.

The telescopic rod locking systems described herein may incorporate an anti-rotation feature designed to prevent unwanted rotational movement between an inner tube and outer tube, ensuring, or substantially ensuring, stable axial alignment during operation. This feature can be achieved through multiple embodiments, depending on the specific application and design requirements of the telescopic system.

In an embodiment, the anti-rotation feature can be implemented by using non-cylindrical cross-sectional shapes for the inner and outer tubes. In this case, the cross-sections of both tubes may be shaped to prevent rotation naturally due to their geometry. Examples of such non-cylindrical shapes include elliptical, Reuleaux triangle, or other polygonal shapes. These shapes restrict rotational movement because the non-circular geometry inherently resists twisting, keeping the inner tube aligned with the outer tube during extension and retraction. This approach can be highly effective for preventing rotational slippage. However, these non-cylindrical shapes may introduce additional manufacturing complexity and cost due to the specialized tooling required for their production.

To address these manufacturing considerations, another embodiment of the anti-rotation feature uses a groove and protrusion system, which allows for use of standard cylindrical shapes for both the inner and outer tubes. In this embodiment, a longitudinal groove is formed along the length of one of the inner or outer tubes, while the other tube is equipped with a corresponding protrusion. When the inner tube is inserted into the outer tube, the protrusion fits into the groove, preventing the tubes from rotating relative to each other.

This groove and protrusion system provides a cost-effective solution to the anti-rotation problem, offering a simpler manufacturing process compared to non-cylindrical shapes while maintaining axial alignment during use. This system ensures, or substantially ensures, that the inner tube can slide freely within the outer tube for extension and retraction but cannot rotate, even when significant rotational forces are applied. Engagement between the groove and protrusion allows for easy operation without introducing additional friction, ensuring, or substantially ensuring, that telescopic adjustments remain effortless for the user.

While the non-cylindrical version of the anti-rotation system provides inherent anti-rotation due to its shape, the groove and protrusion system described herein may use standard cylindrical or substantially cylindrical tubes that are more readily available and easier to manufacture. Both systems can be employed either independently or in combination with the locking mechanism described earlier, depending on the specific application.

The accompanying figures, which are incorporated into and form part of this description, illustrate various aspects and embodiments of the telescopic rod locking systems and anti-rotation features described herein. Together, these figures provide a comprehensive view of the system's design, functionality, and components. The figures are provided for illustrative purposes and are not intended to limit the scope of this description. Variations and modifications to the depicted embodiments may be made without departing from the scope and spirit of the present description.

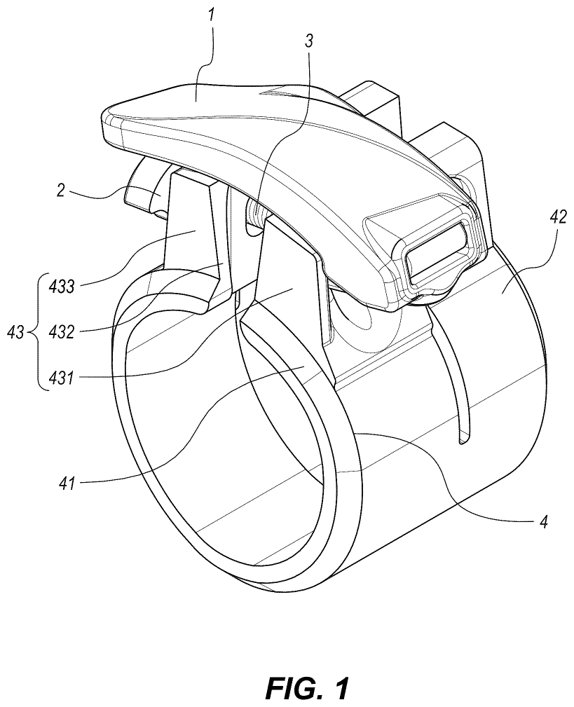

FIG. 1 illustrates a perspective view of the locking mechanism, highlighting components of the locking mechanism. The inner tube and outer tube are not shown in this figure, allowing for a clearer view of the internal structure of the locking mechanism.

The second axial end (41) is designed to engage with the inner tube (not shown). The locking assembly (43), housed within the second axial end, includes the first locking member (431), the second locking member (433), and the V-shaped/substantially V-shaped locking assembly slot (432). The V-shaped, or substantially V-shaped, locking assembly slot ensures, or substantially ensures, that the inner tube (not shown) is securely clamped when the system is engaged.

In the embodiment depicted in FIG. 1, the handle (1) is mounted on top of the clamp body (4) and is operatively connected to the locking bolt (3). When rotated, the handle (1) drives the locking bolt (3) through the locking assembly (43), causing the first locking member (431) and second locking member (433) to move inward in a V-shaped, or substantially V-shaped, configuration (432) and apply clamping force on the inner tube. The locking nut (2) may be used to secure the position of the locking bolt (3) once the desired clamping force is applied.

This perspective highlights the overall structure and function of the locking mechanism. The locking assembly (43), composed of the first locking member (431), the second locking member (433), and the V-shaped, or substantially V-shaped, configuration (432), ensures, or substantially ensures, secure engagement with the inner tube when the handle is rotated to tighten the clamping force.

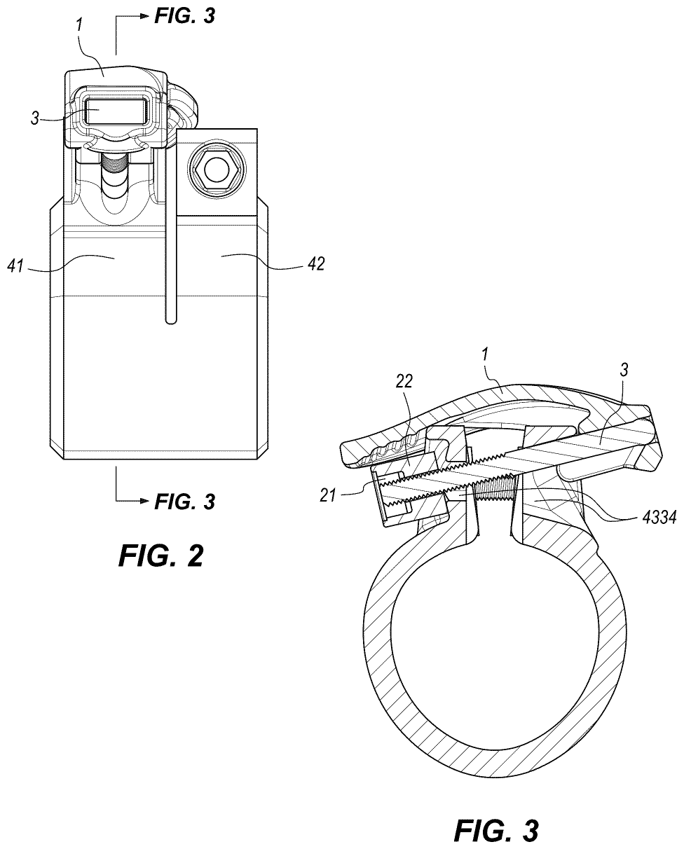

FIG. 2 provides a side view of a locking mechanism according to the present disclosure, showing the handle (1), locking bolt (3), and the structural elements of the first axial end (42) and second axial end (41) of the clamp body.

The handle (1) may be mounted on the clamp body and may be operatively connected to the locking bolt (3). In an embodiment, when rotated, the handle (1) drives the locking bolt (3) through the locking mechanism, controlling engagement of the locking members housed within the second axial end (41). The movement of the locking bolt (3) ensures, or substantially ensures, that the inner tube (not shown) can be secured or released, depending on the rotational position of the handle.

In an embodiment, the first axial end (42) may be fixedly attached to the outer tube (not shown), thereby providing a stable base for the locking mechanism. This end may remain stationary, or substantially stationary, while the second axial end (41) may engage the inner tube for locking or adjustment.

This side view highlights the interaction between the handle (1), locking bolt (3), and the second axial end (41), which engages the inner tube. The simple arrangement of these components allows for precise control over the telescopic rod's locking and release functions.

FIG. 3 provides a cross-sectional view of the locking mechanism, illustrating the internal components involved in securing the inner tube (not shown). This figure specifically labels a handle (1), locking bolt (3), hexagonal nut (21), knob (22), and locking assembly slot (4334).

The handle (1) is shown at the top of the clamp body, connected to the locking bolt (3). When rotated, the handle (1) causes the locking bolt (3) to move through the system. The locking bolt (3) is secured by the nut (21). This arrangement ensures, or substantially ensures, that the locking bolt is properly positioned and can be tightened or loosened as needed to engage or disengage the locking mechanism.

In an embodiment, the substantially V-shaped locking assembly slot (4334) may be located within the second axial end (not shown in this figure) and may be where the locking bolt (3) engages to apply clamping force to the inner tube. The movement of the locking bolt (3) through the locking assembly slot (4334) drives the locking members inward, securing the inner tube in place.

FIG. 3 highlights the interaction between the handle, the locking bolt, and the locking assembly components, showing how the system operates to lock or release the inner tube with precision and control.

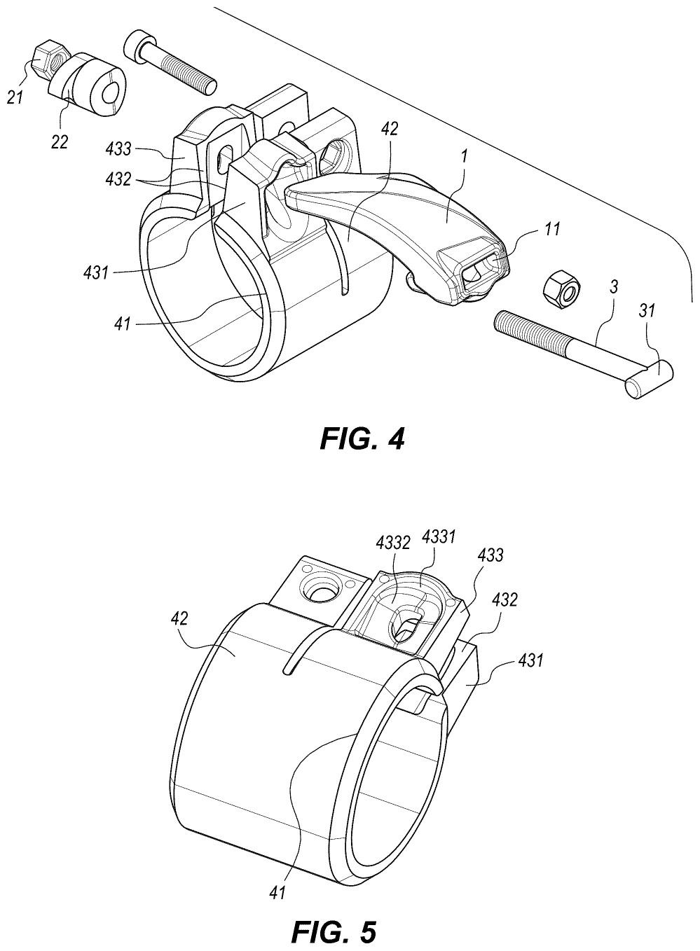

FIG. 4 provides an exploded view of the locking mechanism, showing the individual components and how they fit together. This view shows how the handle (1), locking bolt (3), hexagonal nut (21), and the locking assembly (43) interact.

In an embodiment, the handle (1) may be connected to the locking bolt (3), thereby controlling the clamping operation. According to such embodiment, the locking bolt (3) passes through the handle and interacts with the internal components, including the first locking member (431), second locking member (433), and the V-shaped, or substantially V-shaped, locking assembly slot (432), which allows these locking members to compress inward to clamp the inner tube (not shown).

The locking bolt (3) may be further secured by the hexagonal nut (21) and knob (22), which provide stability and ensure, or substantially ensure, that the locking mechanism remains engaged once the handle is rotated into position.

In an embodiment, the locking assembly (43) may comprise a first locking member (431) and a second locking member (433), configured to form a V-shaped, or substantially V-shaped, locking assembly slot (432), housed within a second axial end (41) of a clamp body. These components may move inward to apply clamping force when the handle is rotated.

Referring still to FIG. 4, the first axial end (42) may be fixedly attached to the outer tube (not shown), thereby providing stability to the telescopic rod locking system.

Additionally, part (11) may serve as a pivot point for the handle (1).

The end part (31) of the locking bolt may secure the locking bolt (3) and allow it to interact with the locking assembly (43).

This exploded view offers a clear representation of how the components may be assembled and work together to operate the locking mechanism. Interaction in the manner described herein between the handle (1), locking bolt (3), locking nut (21), and the locking assembly (43) results in clamping force that secures an inner tube in place.

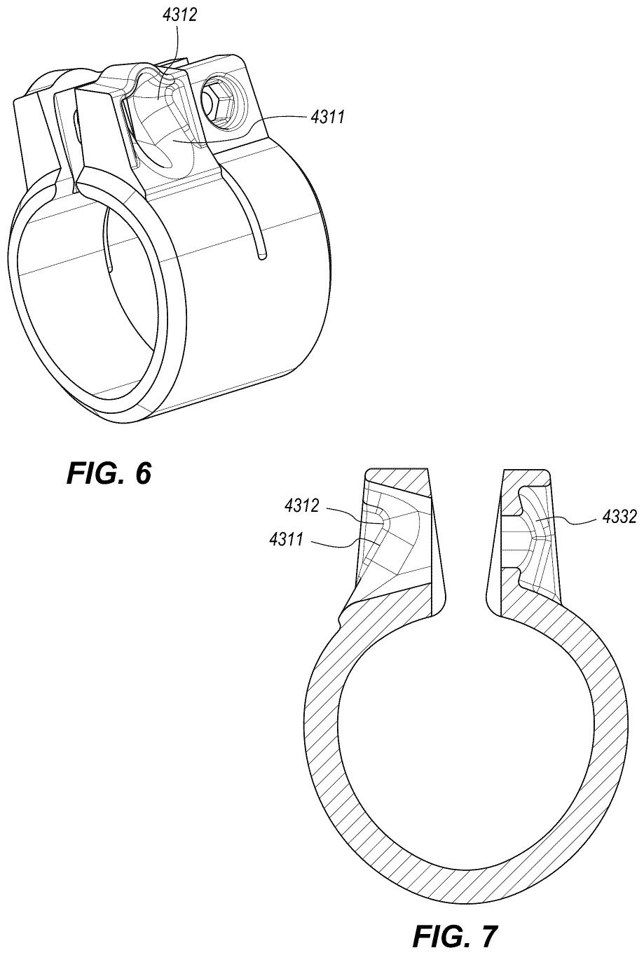

FIG. 5 provides a perspective view of the internal structure of the second axial end (41), particularly the configuration of the locking assembly (43). This figure illustrates how the first locking member (431) and second locking member (433) are arranged within the clamp body to define a V-shaped or substantially V-shaped (432) space, which space constitutes the locking assembly slot.

According to an embodiment of the systems described herein, and as shown in FIG. 5, the first locking member (431) and second locking member (433) may be positioned on either side of the V-shaped or substantially V-shaped configuration (432), and they move inward when the handle (not shown in this figure) is rotated, engaging the inner tube (not shown) and securing it in place.

The second locking member (433) includes a round hole (4331) that is designed to engage with the cylindrical or substantially cylindrical section of the locking mechanism (shown in previous figures). This ensures, or substantially ensures, proper alignment of the locking members during operation.

Additionally, the groove (4332) on the second locking member (433) further helps guide the alignment of the locking mechanism when compressing inward.

The second axial end (41) is shown at the bottom, and the first axial end (42) is positioned above it, indicating that the first axial end (42) is securely attached to the outer tube (not shown).

This figure highlights the detailed structure of the locking assembly (43), demonstrating how the first locking member (431) and second locking member (433) interact in a V-shaped or substantially V-shaped configuration (432) to securely clamp the inner tube when in use.

FIG. 6 provides a perspective view of a first locking member (431) as described herein, focusing on its specific surface structure. This figure highlights the inclined surface (4311) and the first arc-shaped surface (4312) of the first locking member (431).

The inclined surface (4311) is configured to move inward as the handle is rotated. This ensures, or substantially ensures, that the locking members can compress against an inner tube (not shown) positioned within the V-shaped or substantially V-shaped locking assembly slot to securely lock it in place.

The first arc-shaped surface (4312) connects with the inclined surface (4311) and further aids in providing a smooth transition as the locking mechanism is actuated, allowing for secure clamping with minimal wear on the components.

The figure illustrates the structural features of the first locking member (431), emphasizing how the combination of the inclined surface (4311) and first arc-shaped surface (4312) contribute to the overall locking mechanism's smooth and effective operation.

FIG. 7 provides a cross-sectional view of an embodiment of the locking mechanism showing interaction between the locking members.

As shown, the first locking member (431) may include a first inclined surface (4311) and a first arc-shaped surface (4312), which together to facilitate the clamping action.

The second locking member (433) may have a second arc-shaped surface (4332), which complements the first locking member's shape and interacts with it to create a secure clamping arrangement.

In an embodiment, when the locking mechanism is engaged, the locking members (431, 433) may move toward each other, and the arc-shaped surfaces (4312, 4332) may compress against the inner tube, ensuring, or substantially ensuring, a tight, secure lock. This structure distributes the clamping force evenly, or substantially evenly, around the inner tube, reducing stress points and enhancing locking stability.

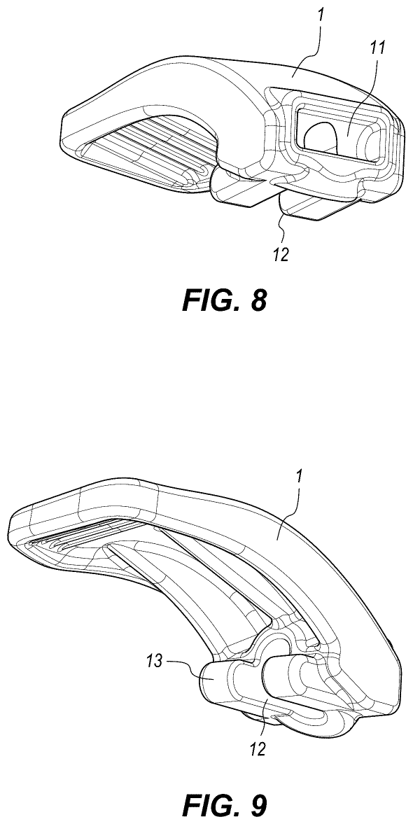

FIG. 8 provides a detailed perspective view of the handle (1) of the locking mechanism.

According to an embodiment, as shown in FIG. 8, the handle (1) may include a first end (11) and a notch (12), which is part of the mechanism that allows the handle to engage with the locking bolt.

The notch (12) and other design features of the handle may enhance operation of the locking and release functions of the overall system, allowing the user to easily tighten or loosen the locking members.

FIG. 9 shows another perspective view of the handle (1) from a different angle, according to an embodiment of the systems described herein. FIG. 9 shows additional structural elements of the handle, according to such embodiment.

FIG. 9 depicts an embodiment wherein a second arc-shaped surface (13) interacts with the locking members to create clamping force when the handle (1) is rotated. This surface may be part of a mechanism that presses the locking members inward, ensuring, or substantially ensuring, secure engagement with the inner tube. The combination of the first arc-shaped surface of the locking members and the second arc-shaped surface (13) of the handle ensures, or substantially ensures, precise control over the locking and release functions.

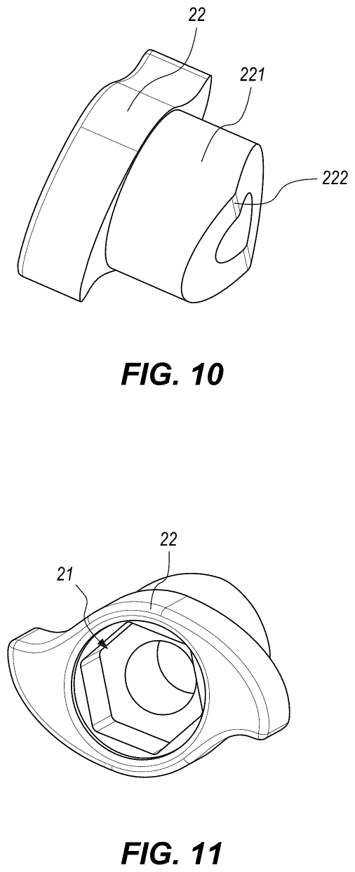

FIG. 10 illustrates a detailed perspective view of a locking nut (21) and an associated knob (22) as described herein.

As shown in FIG. 10, the locking nut may include a substantially cylindrical section (221) and a raised portion (222) that interacts with the locking bolt and handle to secure the locking assembly in place.

According to such embodiment, the raised portion (222) ensures, or substantially ensures, engagement with the corresponding components, providing a reliable means of tightening or releasing the inner tube.

FIG. 11 shows a bottom perspective view of a non-limiting example of a knob (22) and associated locking nut (21), according to an embodiment of this disclosure, specifically highlighting its hexagonal recess. The hexagonal recess is designed to fit securely over the locking bolt (3), allowing the nut to rotate smoothly while maintaining a secure hold on the bolt.

The design of the locking nut (21) provides force to hold the locking members in place, or substantially in place, when the system is engaged.

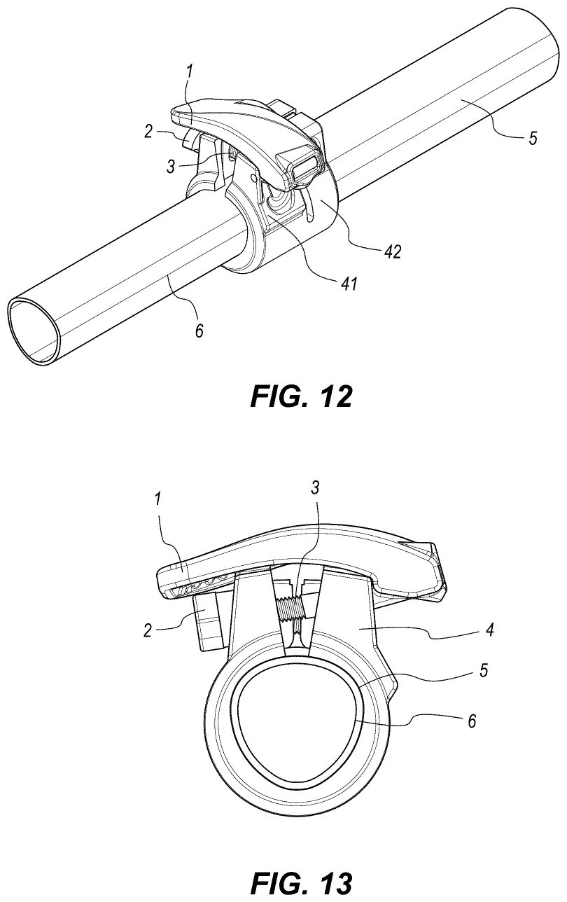

FIGS. 12-13 illustrate the telescopic rod locking system as assembled with an outer tube (5) and an inner tube (6), according to an embodiment of the systems described herein.

According to such embodiment, the handle (1) is connected to the locking assembly, which may be engaged with a locking nut (2) and locking bolt (3), thereby controlling movement of the locking members within the clamp body (4).

The first axial end (42) of the clamp body (4) securely attaches to the outer tube (5), while the second axial end (41) engages the inner tube (6), allowing the system to lock the inner tube (6) in place during extension and retraction.

These figures show how the entire mechanism may be used in the context of a telescopic tube assembly, with the handle (1) facilitating the locking and releasing of the inner tube (6).

According to such embodiment, and as shown in FIG. 13, the handle (1), locking nut (2), and locking bolt (3) are positioned at the top of the clamp body, controlling the movement of the locking members. The first axial end (42) engages the outer tube (5), while the second axial end (41) holds the inner tube (6) securely in place.

This view further clarifies the alignment between the tubes and how the locking mechanism ensures, or substantially ensures, that the inner tube (6) is held within the outer tube (5).

The anti-rotation mechanisms enabled by this disclosure address the problem of unwanted rotational movement between the inner tube (6) and outer tube (5) during extension and retraction. Without a mechanism to prevent this rotation, the stability and alignment of the telescopic system can be compromised, leading to operational inefficiencies.

In an embodiment, the inner and outer tubes may be designed with non-circular cross-sectional shapes, such as Reuleaux triangles or elliptical profiles, without limitation. Such geometries naturally impede rotational movement between the tubes, offering a simple yet effective anti-rotation solution.

In an alternative embodiment, standard cylindrical or substantially cylindrical tubes may be used, wherein one tube may have a longitudinal groove and a second tube may have a corresponding or complimentary protrusion. This improved design allows the tubes to maintain axial alignment during operation, while the groove and protrusion engage to prevent rotation, making it a versatile and cost-effective solution to unwanted rotation.

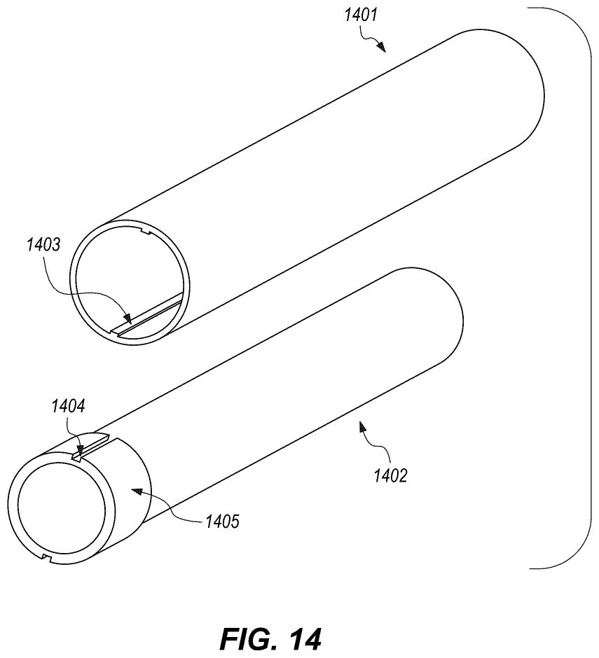

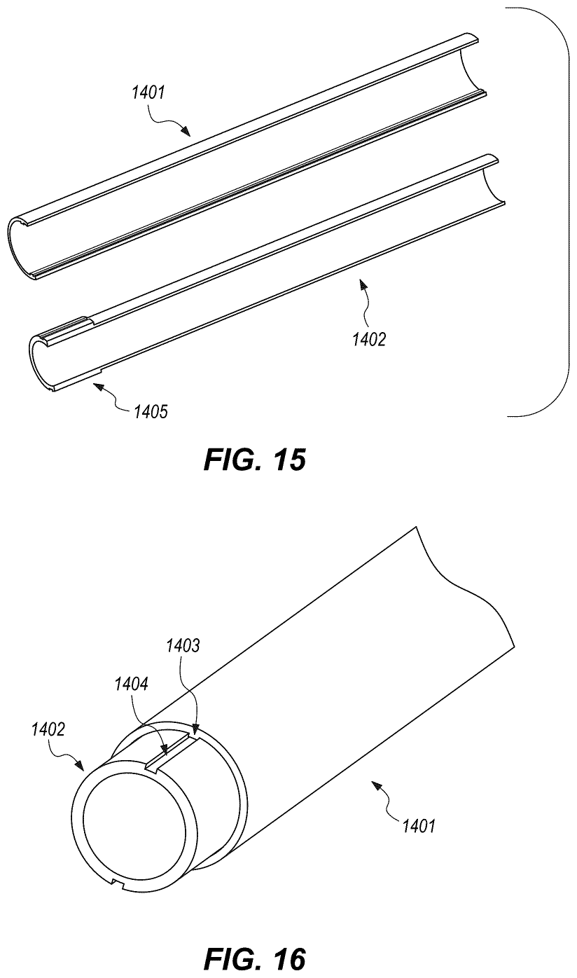

FIGS. 14-16 illustrate an embodiment of the anti-rotation mechanism based on the groove and protrusion system. According to such embodiment, the outer tube (1401) includes two longitudinal protrusions (1403) running along its inner surface. These protrusions engage with corresponding grooves (1404) formed on the outer surface of the inner tube (1402).

According to such embodiment, the inner tube (1402) is configured with these grooves (1404) to receive the protrusions (1403), ensuring, or substantially ensuring, that the inner tube (1402) can slide longitudinally relative to the outer tube (1401) but cannot rotate. This system solves the problem of unwanted rotational movement, providing stable, controlled operation in telescopic systems such as extendable poles or supports.

To reinforce the structural integrity of the groove-bearing portion, the inner tube (1402) may include a reinforced portion (1405) near its end, where the grooves (1404) are located. This reinforced portion adds extra material in the region of the groove, ensuring, or substantially ensuring, that the structural strength of the tube is not compromised by the presence of the grooves.

In an embodiment, the outer tube (1401) includes two internal longitudinal protrusions (1403) that extend along its length. These protrusions are sized and positioned to engage with the grooves (1404) on the inner tube (1402), effectively locking the tubes against rotational movement while allowing smooth axial sliding. The use of two protrusions (1403) provides enhanced stability by distributing the rotational locking forces more evenly around the circumference of the tube. This ensures, or substantially ensures, that even if one protrusion experiences some wear over time, the second protrusion can still maintain, or substantially maintain, the anti-rotation function.

The inner tube (1402) may comprise two longitudinal grooves (1404), which may be formed on an external surface of the inner tube. These grooves (1404) may be configured to receive corresponding protrusions (1403) of the outer tube (1401), ensuring, or substantially ensuring, that the tubes remain axially aligned and preventing, or minimizing, rotation during telescopic adjustments. The use of two grooves, like the two protrusions, offers a balanced distribution of rotational forces, enhancing overall stability of the system.

To prevent or minimize structural weakening of the inner tube at the location of the grooves (1404), in a non-limiting embodiment, the inner tube may include a reinforced portion with additional wall thickness and/or strengthened material. This ensures, or substantially ensures, that the inner tube (1402) can withstand operational stresses, particularly at the points where the grooves are cut.

While FIGS. 14-16 depict grooves (1404) on the inner tube (1402) and protrusions (1403) on the outer tube (1401), one of skill in the art would readily appreciate that this arrangement is illustrative only. The systems enabled by this disclosure are not limited to this specific configuration. In alternative embodiments for example, the arrangement can be reversed, with grooves being on the inner surface of the outer tube and protrusions being on the outer surface of the inner tube. Additionally, while two grooves and protrusions are shown in the embodiment depicted in FIGS. 14-16, the number and positioning of the grooves and protrusions can vary as needed or desired. For instance, a single groove and protrusion could be used, or additional grooves and protrusions could be added for enhanced stability. This flexibility makes the anti-rotation feature adaptable to various telescopic systems, allowing manufacturers to customize the configuration based on the specific use case or application while maintaining anti-rotation functionality.

In some embodiments, as shown in FIGS. 14-16, the grooves (1404) on the inner tube (1402) and the protrusions (1403) on the outer tube (1401) may be symmetrically positioned around the circumference of the tubes. This symmetrical arrangement ensures, or substantially ensures, that the grooves and protrusions are evenly distributed around the inner and outer tubes, providing balanced engagement between the two components. This configuration allows for secure engagement of the groove and protrusion system, while maintaining the ability for the inner tube (1402) to slide longitudinally within the outer tube (1401) without rotational movement. The number and positioning of the grooves and protrusions can vary, depending on the requirements of the telescopic system, but in this embodiment depicted in FIGS. 14-16, two symmetrically positioned grooves and protrusions are used for enhanced structural balance.

This disclosure further enables a multi-stage telescopic rod locking system that operates substantially identically to the single-stage systems described herein, except that they comprise a plurality of inner tube/locking mechanism assemblages. These multi-stage telescopic rod locking systems may comprise a series of concentric tubes, each such tube configured to retract out and collapse into the outer tube.

As with the systems described above, this multi-stage system may also incorporate an anti-rotation mechanism to prevent unwanted rotational movement. In an embodiment, and as with the other systems described above, the anti-rotation mechanism may include a groove and protrusion system, wherein a longitudinal groove is formed along the length of a tube, and a corresponding protrusion is formed on the adjacent tube. The groove and protrusion may engage thereby allowing for extension and retraction, ensuring, or substantially ensuring, that the tubes remain axially aligned and do not rotate relative to each other. This anti-rotation mechanism can be used either independently or in combination with the locking mechanism to provide enhanced stability during operation According to such an embodiment, each inner tube may be sequentially nested within the outer tube. Such a system can be extended and retracted to various lengths, as desired depending on the application. Such a system may include a plurality of locking mechanisms. In one non-limiting embodiment, each such locking mechanism may correspond to an inner tube and may be configured to releasably engage such inner tube. Such an arrangement would allow each inner tube to be locked in place or released as needed.

According to such an embodiment, each locking mechanism may comprise a clamp body comprising a first axial end fixedly engaged with the outer tube, and a second axial end configured to releasably engage an inner tube. This configuration allows each inner tube to be locked or released relative to the outer tube. When such a system is in a fully collapsed state, all tubes of the multi-stage system are retracted and nested within one another, inside the outer tube ultimately, providing a compact configuration for storage or transport.

In such a multi-stage system, each inner tube may be independently extended or retracted and locked into position. Each locking mechanism may engage an inner tube in a substantially identical manner to the single-stage locking mechanisms discussed above to prevent axial movement when the system is locked. The locking mechanism, as with the single-stage systems described above, typically includes a handle, which controls engagement of locking members that move radially inward to secure an inner tube in place. The handle can be rotated to either engage or release the locking members, allowing the user to adjust the position of the inner tube within the system.

This multi-stage telescopic rod locking system is highly adaptable and can be configured with varying numbers of inner tubes and locking mechanisms depending on the desired length of extension. Each locking mechanism allows for independent control over the position of its corresponding inner tube, meaning that the system can be partially or fully extended based on the user's needs. This flexibility makes the system ideal for applications where precise adjustment of length is sought, such as in extendable poles, supports, or arms.

When fully retracted, all inner tubes are securely locked within the outer tube, resulting in a compact, easily transportable configuration. The ability to selectively extend individual tubes allows for fine-tuned adjustments to the overall length of the system, while the anti-rotation feature, if present, ensures, or substantially ensures, that the tubes remain aligned and stable during use. The locking mechanism's quick-release functionality further enhances the system's usability, enabling smooth and efficient adjustments.

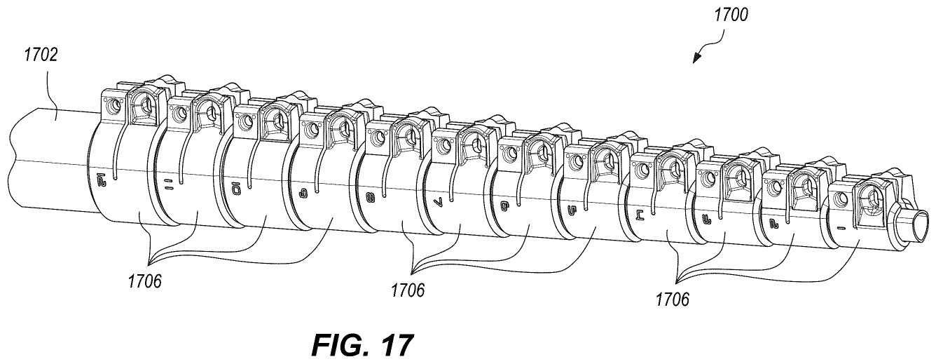

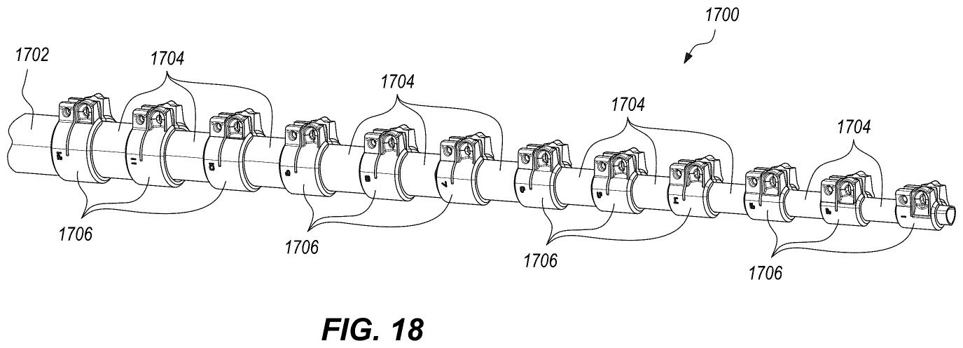

FIGS. 17 and 18 illustrate a multi-stage telescopic rod locking system (1700) as described herein in a fully collapsed and a partially extended configuration, respectively. The system comprises an outer tube (1702), multiple inner tubes (1704), and a plurality of locking mechanisms (1706) designed to lock and release the inner tubes as desired for extension or retraction.

In an embodiment such as that depicted in FIG. 17, which constitutes a fully collapsed configuration, the outermost tube (1702) houses all of the inner tubes (1704), which are nested concentrically inside one another. The locking mechanisms (1706) are fixedly attached to the outer tube (1702), and each clamp body is aligned with a corresponding inner tube. In this state, all the inner tubes are retracted, and the system forms a compact assembly, ideal for storage or transport. The handles (1708) of each locking mechanism remain disengaged, allowing the inner tubes to remain nested inside the outer tube.

FIG. 18 demonstrates the system in a partially extended configuration, where several inner tubes (1704) have been extended out of the outer tube (1702). Each locking mechanism (1706) is shown engaging its corresponding inner tube at the second axial end. The handles (1708) on the locking mechanisms are rotated to engage the locking mechanisms, which prevent axial movement of the inner tubes once they have been extended to the desired position. This figure showcases the telescopic nature of the system, allowing for precise adjustment of the length by extending and locking individual inner tubes. This multi-stage telescopic system (1700) allows for controlled and secure extension and retraction of each inner tube, ensuring, or substantially ensuring, stability and adjustability in various applications.

The telescopic rod locking systems described herein are designed with flexibility in both dimensions and materials to meet the needs of various applications. By way of example and without limitation, the outer tube can have a diameter ranging from 10 millimeters (“mm”) to 150 mm, allowing for use in both small, portable systems and large, heavy-duty applications. In some configurations, outer tube diameters may be between 15 mm and 40 mm for lighter systems, or between 50 mm and 100 mm for systems requiring greater load-bearing capacity. In some embodiments, the inner tube may have a diameter slightly smaller than the outer tube, ranging from 8 mm to 145 mm, without limitation. For example, an outer tube with a 40 mm diameter may be paired with an inner tube of 36 mm, while an outer tube of 80 mm may accommodate an inner tube of 75 mm. Those of skill in the art will readily appreciate alternative dimensions that are likewise consistent with maintaining sound operation of the systems described herein.

The telescopic rod locking systems described herein may be constructed with varying tube lengths depending on its intended application. Without limitation, outer tubes as described herein may range from 0.5 meters to over 5 meters in length. In its collapsed form, the systems may measure around 1 meter in length, and in its fully extended form, it may reach 30 meters or more in length; the foregoing constituting non-limiting examples only. Wall thicknesses for the tubes can range from 0.4 mm to 10 mm, preferably from 0.5 mm to 3 mm, without limitation, providing the necessary balance of strength and weight. Thinner walls, around 1 mm to 2 mm, may be used for lighter applications, while thicker walls, such as 8 mm to 10 mm or greater, may be used for applications requiring additional strength and rigidity.

The materials used in the telescopic rod locking systems described herein may be selected for purposes of enhancing performance, durability, and weight optimization. Metals, such as aluminum alloys, offer a balance of strength and corrosion resistance while maintaining a lightweight structure. These alloys may be used to construct the outer and inner tubes, providing robust support across a variety of environmental conditions. Stainless steel, including specific grades designed for strength and corrosion resistance, may be used in components that require higher wear resistance, such as the components of the locking mechanism. Stainless steel adds durability to components exposed to higher stress or harsh environmental conditions.

Composites, including carbon fiber, may be integrated into the systems described herein to combine lightweight properties with high strength. Carbon fiber may be used in the tubes or other structural elements, providing rigidity while minimizing weight. Plastics, such as polycarbonate, may be employed in the clamp body, reducing weight while maintaining durability and impact resistance. Reinforced plastics, including fiberglass-reinforced materials, may also be used to strengthen certain structural elements of the systems described herein, such as, without limitation, the locking members, while ensuring or substantially ensuring that the overall structure remains lightweight and easy to handle.

The materials identified above that may be used to make components of the systems described herein are provided as examples only and are not intended to be limiting. Those of skill in the art will readily appreciate alternative materials that may be used to make the components of locking mechanisms, as well as inner and outer tubes, as described herein.

These dimensions and materials enable the telescopic rod locking systems described herein to be adapted for a wide range of applications, from portable, lightweight designs to more robust, heavy-duty configurations.

While various aspects have been described in the above disclosure, this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims. All numbers, measurements, and values are given as approximations unless expressly stated otherwise.

What is claimed is:

1. A telescopic rod locking system, comprising:
an outer tube;
an inner tube configured to extend from and retract into the outer tube; and
a locking mechanism comprising:
a clamp body comprising:
a first axial end fixedly engaged with the outer tube; and
a second axial end configured to releasably engage the inner tube, allowing for the inner tube to be longitudinally locked or released relative to the outer tube.

2. The telescopic rod locking system of claim 1, wherein a groove is formed along the length of one of the inner tube or the outer tube, and a protrusion is formed along the length of the other of the inner tube or the outer tube, and wherein the groove and the protrusion are configured to engage with each other.

3. The telescopic rod locking system of claim 2, wherein the groove is formed along the length of the outer surface of the inner tube, and the protrusion is formed along the length the inner surface of the outer tube.

4. The telescopic rod locking system of claim 3, wherein two grooves are formed along the length of the inner tube, and two corresponding protrusions are formed along the length of the outer tube.

5. The telescopic rod locking system of claim 4, wherein the grooves are symmetrically positioned around the circumference of the inner tube and the protrusions are symmetrically positioned around the circumference of the outer tube.

6. The telescopic rod locking system of claim 1, wherein the locking mechanism further comprises a handle operatively connected to a locking bolt to engage or release the inner tube.

7. The telescopic rod locking system of claim 6, wherein the locking mechanism further comprises a locking assembly comprising first and second locking members positioned at the second axial end of the clamp body, wherein the first and second locking members are configured to move radially inward to engage the inner tube when the handle is rotated.

8. The telescopic rod locking system of claim 7, wherein the first and second locking members are positioned relative to one another so as to define a substantially V-shaped locking assembly slot.

9. The telescopic rod locking system of claim 8, wherein the locking bolt passes through the locking members, is engaged with a locking nut, and controls radial movement of the locking members.

10. The telescopic rod locking system of claim 1, wherein the first axial end of the clamp body is fixedly attached to the outer tube through a fastening mechanism selected from bolts, rivets, or adhesives.

11. The telescopic rod locking system of claim 1, wherein the inner and outer tubes have substantially circular cross-sectional shapes.

12. The telescopic rod locking system of claim 1, wherein the inner and outer tubes have non-circular cross-sectional shapes.

13. The telescopic rod locking system of claim 1, wherein the inner tube comprises a reinforced portion at an end thereof, wherein the groove is formed on the reinforced portion.

14. A multi-stage telescopic rod locking system, comprising:
an outer tube;
a plurality of inner tubes, each configured to extend from and retract into an outer tube; and
a plurality of locking mechanisms each comprising a clamp body, wherein each clamp body comprises:
a first axial end fixedly engaged with the outer tube; and
a second axial end configured to releasably engage an inner tube, allowing for the inner tube to be longitudinally locked or released relative to the outer tube.

15. The multi-stage telescopic rod locking system of claim 14, wherein each of the plurality of locking mechanisms comprises a handle operatively connected to a locking bolt to engage or release the inner tube.

16. The multi-stage telescopic rod locking system of claim 15, wherein each of the plurality of locking mechanisms comprise a locking assembly comprising a first locking member and a second locking member, both positioned at a second axial end of each clamp body, wherein the first and second locking members are configured to move radially inward to engage the inner tube when the handle is rotated.

17. The multi-stage telescopic rod locking system of claim 16, wherein the first and second locking members are positioned relative to one another so as to define a substantially V-shaped locking assembly slot.

18. The multi-stage telescopic rod locking system of claim 17, wherein the outer tube and each of the plurality of inner tubes comprise substantially circular cross-sectional shapes.
